(19) United States
(12) Patent Application Publication
(10) Pub. No.: US 2021/0347667 A1
(43) Pub. Date: Nov. 11, 2021

(54) CO-DEPOSITION OF OIL SAND TAILINGS STREAMS AND TAILINGS PRODUCTS

(71) Applicants: SYNCRUDE CANADA LTD. in trust for the owners of the Syncrude Project as such owners exist now and in, Fort McMurray (CA); CANADIAN NATURAL RESOURCES LIMITED, Calgary (CA)

(72) Inventors: ADEDEJI DUNMOLA, Edmonton (CA); ERIC LeNEVE, Morinville (CA); JONATHAN SPENCE, Edmonton (CA); ROBERTINO HERTANTO, Fort McMurray (CA); NAN WANG, Edmonton (CA); RANDY MIKULA, Edmonton (CA); JAMES LORENTZ, Fort McMurray (CA); PETER READ, Fort McMurray (CA)

(21) Appl. No.: 16/867,417

(22) Filed: May 5, 2020

(51) Int. Cl. C02F 11/148

(52) U.S. Cl. CPC C02F 11/148; C02F 2103/10

(57) ABSTRACT

A process for co-depositing tailings streams and/or tailings products is provided comprising providing a tailings containment structure; and co-depositing at least two different tailings streams and/or tailings products into the tailings containment structure.

### FIELD OF THE INVENTION

The present invention relates to the co-deposition of at least two different tailings in a tailings containment structure, in particular, oil sand tailings.

### BACKGROUND OF THE INVENTION

Extraction tailings, such as oil sand extraction tailings, are generated from extraction operations that separate valuable material from the mined ore. In the case of oil sand ore, heavy oil or bitumen is extracted from the ore using water, which is added to the oil sand ore to enable the separation of the valuable hydrocarbon fraction from the oil sand minerals.

Oil sand generally comprises water-wet sand grains held together by a matrix of viscous heavy oil or bitumen. Bitumen is a complex and viscous mixture of large or heavy hydrocarbon molecules that contain a significant amount of sulfur, nitrogen and oxygen. The extraction of bitumen from oil sand using hot water processes yields extraction tailings composed of coarse sand, fine silts, clays, residual bitumen and water. Mineral fractions with a particle diameter less than 44 microns are herein referred to as “fines.” These fines are typically clay mineral suspensions, predominantly kaolinite and illite.

Conventionally, oil sand extraction tailings have been transported to a deposition site contained within a dyke structure generally constructed by placing the coarse sand fraction of the tailings on beaches. The process water, unrecovered hydrocarbons, together with sand and fine materials that are not trapped in the dyke structure flow into a pond, where the coarse sand settles quickly to the bottom of the pond while the finer mineral solids remain in suspension.

The fine tailings suspension is typically 85% water and 15% fine particles by mass. Dewatering of fine tailings occurs very slowly. When first discharged in ponds, the very low density material is referred to as “thin fine tailings”. After a few years when the thin fine tailings have reached a solids content of about 30-35%, they are referred to as mature fine tailings (MFT), which behave as a fluid-like colloidal material. MFT, which has a low solids to fines ratio (<0.3), is often referred to as a type of “fluid fine tailings” (FFT). FFT is generally defined as a liquid suspension of oil sands fines in water with a solids content greater than 2% and having less than an undrained shear strength of 5 kPa. The fact that fluid fine tailings behave as a fluid and have very slow consolidation rates significantly limits options to reclaim oil sand tailings ponds.

It is particularly challenging to dewater or solidify fluid fine tailings (FFT) to the point where these tailings can support standard reclamation equipment and techniques. Recently, the present Applicant developed a process for dewatering oil sand tailings, including FFT, by treating tailings with a coagulant and a flocculant prior to dewatering by centrifugation (see, for example, Canadian Patent No. 2,787,607). The centrifugation process is particularly useful with, but not limited to, fluid fine tailings (FFT), and produces a centrifuge cake for further reclamation. In the Applicant's operation, the coagulant used is gypsum (calcium sulfate dihydrate). It was found that gypsum addition helped to increase throughput by creating a stronger cake, allowing for more aggressive removal rates and therefore higher tonnes per hour per machine.

Another process developed by the present Applicant to address the issue of fluid fine tailings (FFT) is the composite tailings (CT) process, which involves combining a process aid such as a coagulant and sand with FFT. CT technology causes the FFT to consolidate faster and produce non-segregating tailings (also known as NST). Early work to develop the CT process identified a number of suitable process aids including lime, polymers, acid, carbon dioxide, gypsum, alum, and combinations thereof (see Matthews, J. G., Shaw, W. H., Mackinnon, M. D., and Cuddy, R. G. (2002). Development of composite tailings technology at Syncrude, International Journal of Surface Mining, Reclamation and Environment, 16(1), 24-39). For the Applicant's commercial CT process, gypsum was selected as the process aid of choice.

Another method developed by the present applicant for improving the dewatering of fluid fine tailings is to treat the tailings with a flocculant such as a high molecular weight nonionic, anionic, or cationic polymer to create a floc structure that will dewater rapidly when deposited in dewatering cells.

The current state of the art is to separate different tailings streams or products by internal dykes in order to prevent any interaction (FIG. 1). All current tailings streams (e.g. centrifuge cake, FFT, composite tailings, straight coarse tailings, in-line flocculated FFT, co-mix, etc.) produced at the applicant's mine are kept isolated from each other. However, building such internal dykes is costly and takes valuable real estate away from tailings containment. Also, the rate of rise of tailings streams on either side of the internal dykes is constrained by the need to maintain a hydraulic balance across the geotechnical structure. This in turn constrains both mine and tailings planning and operations.

Thus, there is a need in the industry for a deposition strategy that does not require the isolation of the various tailings streams or products with internal dykes, which will be more cost-effective, will optimize the storage efficiency of current and future tailings structures, and allow for greater flexibility of mine and tailings planning and operations.

### SUMMARY OF THE INVENTION

There is a need for a proven deposition technology where two or more tailings streams or tailings products can be co-deposited without being separated by internal dykes. Such co-deposition technique must ensure the overall geotechnical stability and long-term performance of the individual tailings stream or products. Also, the co-deposited tailings materials at the interface(s) should be as good or better than the individual tailings stream or tailings product, both in the short and longer terms.

The aim of the current invention is to eliminate the current practice of separating various tailings streams and tailings products by internal dykes. According to one aspect of the present invention, it was surprisingly found that tailings streams and tailings products can be co-deposited into a common containment structure without separation by internal dyke(s); the tailings streams/products are allowed to interact at the interface without any detrimental impact to the long-term performance of the individual stream/product as well as the interface(s) between them.

Thus, in one aspect, the present invention is directed to a process for co-depositing tailings streams and/or tailings products comprising:
providing a tailings containment structure;
co-depositing at least two different tailings streams and/or tailings products into the containment structure.

In one embodiment, the tailings streams are tailings derived from oil sands extraction operations that contain a fines fraction. In one embodiment, the tailings streams are selected from the group consisting of straight coarse tailings, fluid fine tailings (FFT) such as mature fine tailings (MFT) from tailings ponds, and fine tailings from ongoing oil sands extraction operations.

In one embodiment, the tailings products are oil sands tailings that have been treated to aid in the consolidation of the tailings. In one embodiment, the tailings products are selected from the group consisting of fluid fine tailings centrifuge cake, composite tailings and in-line flocculated fluid fine tailings, froth treatment tailings and fluid fine tailings mixed with clay shale.

In one embodiment, the at least two different tailings streams and/or tailings products comprises composite tailings and in-line flocculated fluid fine tailings. In one embodiment, the at least two different tailings streams and/or tailings products comprises fluid fine tailings centrifuge cake and in-line flocculated fluid fine tailings.

In one embodiment, the tailings containment structure is partially filled with fluid fine tailings and recycle water and the at least two different tailings streams and/or tailings products comprises composite tailings and in-line flocculated fluid fine tailings, whereby the composite tailings and in-line flocculated fluid fine tailings are laterally co-deposited sub-aqueously into the fluid fine tailings and recycle water (RCW). In one embodiment, the tailings containment structure is partially filled with fluid fine tailings and recycle water and the at least two different tailings streams and/or tailings products comprises composite tailings and in-line flocculated fluid fine tailings, whereby the composite tailings and in-line flocculated fluid fine tailings are laterally co-deposited sub-aerially into the fluid fine tailings and recycle water (RCW)

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a schematic of the tailings containment structure used in the Prior Art for containing tailings streams or tailings products.

FIG. 2 is a schematic of an embodiment of a tailings containment structure of the present invention for containing tailings streams or tailings products.

FIG. 3A is a schematic of a tailings containment structure whereby composite tailings and flocculated fluid fine tailings are co-deposited into fluid fine tailings and recycle water present in the tailings containment structure.

FIG. 3B is a schematic of one embodiment of the present invention whereby flocculated fluid fine tailings are first allowed to dewater in the tailings containment struction followed by co-deposition of fluid fine tailings centrifuge cake.

FIG. 3C is a schematic of another embodiment of the present invention whereby flocculated fluid fine tailings and fluid fine tailings centrifuge cake are simultaneously co-deposited into a tailings containment structure.

FIG. 4 is a graph showing static yield stress values measured from the co-deposition of composite tailings (CT) with in-line flocculated FFT (fFFT) sub-aqueously into a mixture of fluid fine tailings (FFT) and recycle water (RCW) after 167 days.

FIG. 5 is a graph showing shear stress measured in-situ with the vane shear rheometer and corrected for the rheometer shaft for one embodiment of co-deposition of fluid fine tailings centrifuge cake and flocculated fluid fine tailings.

FIG. 6 is a graph showing shear stress measured in-situ with the vane shear rheometer and corrected for the rheometer shaft for another embodiment of co-deposition of fluid fine tailings centrifuge cake and flocculated fluid fine tailings.

### DETAILED DESCRIPTION OF THE PREFERRED EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

The present invention relates generally to a process for dewatering tailings and, more particularly, to dewatering tailings and tailings products. As used herein, the term “tailings streams” means any tailings that are generated from extraction operations that separate valuable material from mined ore, including tailings derived from oil sands extraction operations that contain a fines fraction. The term is meant to include straight coarse tailings, fluid fine tailings (FFT) such as mature fine tailings (MFT) from tailings ponds and fine tailings from ongoing extraction operations (for example, thickener underflow or froth treatment tailings) which may bypass a tailings pond. The term “tailings products” refers to tailings that have in some way been treated to aid in the consolidation of the tailings, such as centrifuge cake, composite tailings, in-line flocculated FFT, froth treatment tailings and fluid fine tailings mixed with clay shale, etc.

As used herein, a “co-deposition” generally refers to depositing at least two different tailings streams and/or tailings products into a common containment structure such as a dyke without separation of the at least two tailings streams/products by internal dyke(s). Many of the various tailings streams and products and the combinations thereof which can be used for co-deposition are unique to the present applicant's operations. In one aspect, the materials used for co-deposition are treated tailings products. The tailings products may be deposited laterally or horizontally.

As used herein, the term “coagulant” refers to a reagent which neutralizes repulsive electrical charges surrounding particles to destabilize suspended solids and to cause the solids to agglomerate. Suitable coagulants include, but are not limited to, alum, aluminum chlorohydrate, aluminum sulphate, lime (calcium oxide), slaked lime (calcium hydroxide), calcium chloride, magnesium chloride, iron (II) sulphate (ferrous sulphate), iron (III) chloride (ferric chloride), sodium aluminate, gypsum (calcium sulphate dehydrate), Flue Gas Desulfurization Solids, or any combination thereof.

As used herein, the term “flocculant” refers to a reagent that bridges the neutralized or coagulated particles into larger agglomerates, resulting in more efficient settling. Flocculants useful in the present invention are generally anionic, nonionic, cationic or amphoteric polymers, which may be naturally occurring or synthetic, having relatively high molecular weights. Preferably, the polymeric flocculants are characterized by molecular weights ranging between about 1,000 kD to about 50,000 kD. Suitable natural polymeric flocculants may be polysaccharides such as dextran, starch or guar gum. Suitable synthetic polymeric flocculants include, but are not limited to, charged or uncharged polyacrylamides, for example, a high molecular weight polyacrylamide-sodium polyacrylate co-polymer.

Other useful polymeric flocculants can be made by the polymerization of (meth)acrylamide, N-vinyl pyrrolidone, N-vinyl formamide, N,N dimethylacrylamide, N-vinyl acetamide, N-vinylpyridine, N-vinylimidazole, isopropyl acrylamide and polyethylene glycol methacrylate, and one or more anionic monomer(s) such as acrylic acid, methacrylic acid, 2-acrylamido-2-methylpropane sulphonic acid (ATBS) and salts thereof, or one or more cationic monomer(s) such as dimethylaminoethyl acrylate (ADAME), dimethylaminoethyl methacrylate (MADAME), dimethydiallylammonium chloride (DADMAC), acrylamido propyltrimethyl ammonium chloride (APTAC) and/or methacrylamido propyltrimethyl ammonium chloride (MAPTAC). Particularly useful is an aqueous solution of an anionic polyacrylamide. The anionic polyacrylamide preferably has a relatively high molecular weight (about 10,000 kD or higher) and medium charge density (about 20-35% anionicity), for example, a high molecular weight polyacrylamide-sodium polyacrylate co-polymer. The preferred flocculant may be selected according to the tailings composition and process conditions.

As used herein, “fluid fine tailings” or “FFT” is a liquid suspension of oil sand fines in water with a solids content greater than 2%. “Fines” are mineral solids with a particle size equal to or less than 44 μ. “Mature fine tailings” or “MFT” are FFT with a low sand to fines ratio (SFR), i.e., less than about 0.3, and a solids content greater than about 30%.

With reference now to FIG. 1 (Prior Art), the current state of separating multiple tailings streams or products by internal dykes is shown. A tailings containment structure 10 contains an internal dyke 12, where tailings product 14 is deposited on one side of dyke 12 and tailings product 16 is deposited on the other side of the internal dyke 12. However, building such internal dykes is costly and takes valuable real estate away from tailings containment. Also, the rate of rise of tailings streams on either side of the internal dykes is constrained by the need to maintain a hydraulic balance across the geotechnical structure. This in turn constrains both mine and tailings planning and operations.

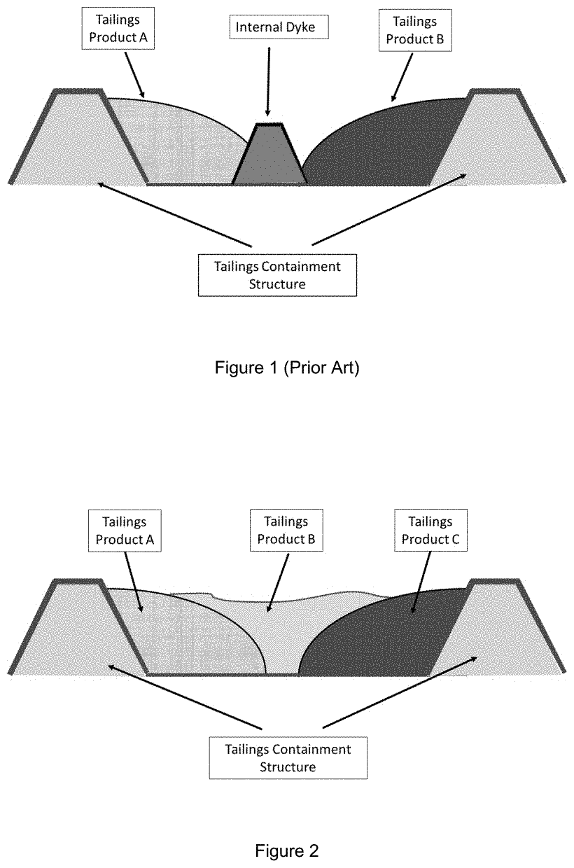

One embodiment of the present invention is shown in FIG. 2. With reference to FIG. 2, a tailings containment structure 210 is shown which does not have internal dykes therein. Instead, three separate tailings products 214, 216 and 218 are proactively deposited into the tailings containment structure 210 side by each, each being allowed to be in contact with one another. It was shown by the applicant that if the right combination of tailings products are used, the tailings products are allowed to interact at the interface without any degradation of the bulk geotechnical performance.

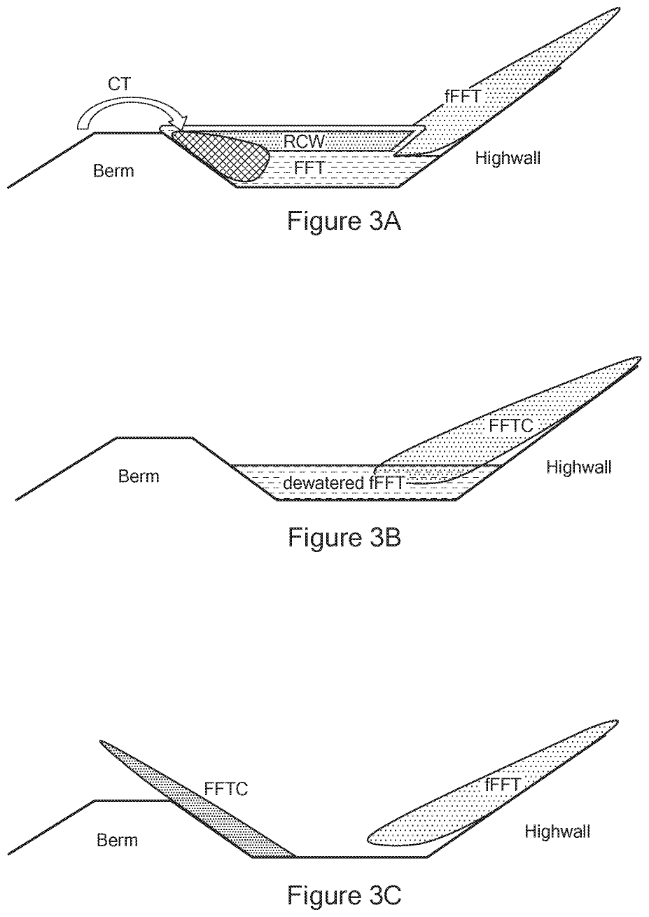

Three different real life scenarios were tested in the lab on a smaller scale as shown in the Examples below. The scenario shown in FIG. 3A depicts a deposition cell comprising a berm at one end and high wall at the other. In this scenario, composite tailings (CT) were poured at the berm end while flocculated FFT (fFFT) would be deposited down the high wall. The deposition cell contained FFT at the bottom AND a layer of recycled water (RCW) on top of the FFT. The CT and fFFT are both poured through the layers of FFT and RCW. This represents a real life scenario where treated tailings will be deposited into an existing tailings pond comprising mature fine tailings and recycle water. FIG. 3B shows a scenario where a deposition cell comprising a berm at one end and high wall at the other is first filled with fFFT, which is then allowed to dewater for a certain period of time. Fluid fine tailings centrifuge cake (FFTC) is then poured on top of the dewatered fFFT. In a third scenario, shown in FIG. 3C, FFTC is poured into an empty deposition cell comprising a berm at one end and high wall at the other, at the berm end and fFFT is poured at the high wall end. It is understood in the art, however, that the berm and high wall is just an example of a suitable geotechnical containment structure. Containment structures could be substituted by any other geotechnical-competent containment structure (e.g. natural features like mountains, overburden dump, etc.).

The following examples demonstrate that when various tailings streams and products are co-deposited, it improved their individual performance over time, including the material at the interface.

### Example 1

In this example, two treated tailings products, namely, composite tailings (CT) and in-line flocculated FFT (fFFT) were laterally co-deposited sub-aqueously into a mixture of FFT and Recycle Water (RCW) present in a test flume. Test flumes were constructed with modular steel frames so that they could be taken apart and re-configured into flumes of different lengths if desired. Each module section is 1.5 m long (60″) and has two 1″ acrylic windows bolted into either side (i.e. 4 windows per section). The overall dimension of the test flume was 0.5 m wide×4.5 m long×2 m deep with solid 2 m end plates. This was used to test the co-deposition scenario as shown in FIG. 3A.

To produce fFFT for deposition in the test flumes, a flocculation rig with appropriate tanks, mixers, pumps, and dynamic mixer was used. This rig can produce fFFT at a rate of 20-30 1/min. The dynamic mixer is 4″ diameter and uses two 3.125″ diameter 45° pitched blade turbine (PBT) impellers. For all cases, FFT was mixed with 1000 g/tonne of gypsum and an anionic polyacrylamide polymer, SNF-A3338, dosed at˜1000 ppm solids and mixer Kc value of˜65 (i.e. dynamic mixer speed 1400-1500 rpm). For each batch of fFFT produced the final dosage and mixing was tuned by observation and the result tested with a capillary suction test (CST). The target CST was below 10 seconds for acceptable fFFT production for this test. The CT was prepared by combining 765 kg sand, 0.52 m³ FFT, 0.19 m³ RCW and 1.2 kg gypsum.

First a tote of FFT and a tote of RCW water were added to the flume (FFT=670 L, 776 kg, 21.8% solids, 72.9% water, and 5.2% bitumen and RCW=670 L, 674 kg, 0.6% solids). Next, approximately 1400 L=1690 kg of fFFT (fFFT=27.8% solids, 69.7% water, 2.5% bitumen) having a CST of between 4 and 6 seconds were added to the test flume. The fFFT was pumped into the left-hand side of the flume with a hose that was kept just above the free surface through the fill. Simultaneously, approximately 1400 litres=2200 kg of CT (CT=58.2% solids, 40% water, 1.8% bitumen) were added to the flume. The CT was pumped into the right-hand side of the flume through a hose kept just above or at the free surface through the fill.

The primary technique for evaluating the deposit strength in the flume tests was by vane shear measurements. These tests were done in-situ in the flumes using a Brookfield 5×HB DVIII rheometer and a customized shaft extension to provide sufficient reach to get to the material in the flume and extend deep into the tailings layers at the bottom of the flume.

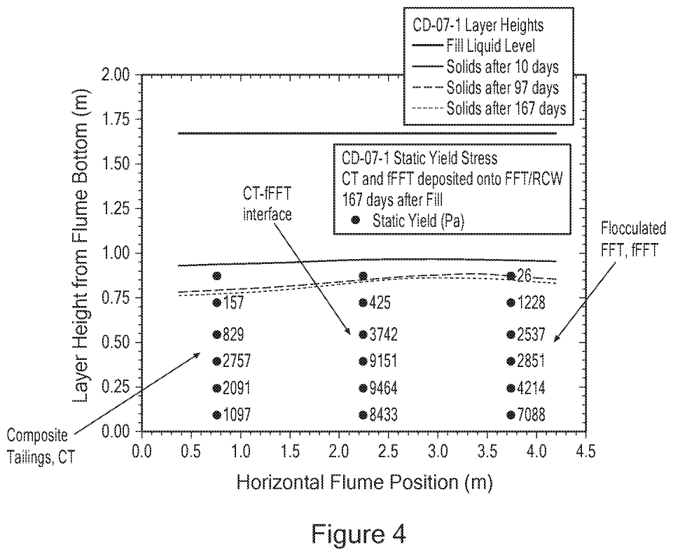

FIG. 4 shows sample data, in particular, static yield (Pa) stresses measured at various locations and profile depths of the test flume at day 167 after co-deposition. It can be seen that the static yield stresses of the CT and fFFT increased over time from the baseline values of 300-700 Pa and 200-350 Pa, respectively. However, the static yield stresses of the CT and fFFT (on either side of the flume) increasing over time shows that co-deposition did not adversely affect the individual dewatering performance of each tailings product. In addition, the middle section where they interact showing much higher static yield stress illustrates that the interface properties and behavior are also not adversely affected.

### Example 2

This test was performed to demonstrate the efficacy of the co-deposition scenario as shown in FIG. 3B. A flume was first filled with fFFT. The fFFT was produced by mixing FFT with gypsum at 1000 g/tonne solids and flocculating the mixture in the dynamic mixer running at 1460 rpm with a Kc value of 63 mixing using a 0.4% SNF-A3338 polymer solution to give 954 ppm of polymer to solids. The CST of fFFT was between 2 and 8 seconds. The fFFT comprised 28.8% solids, 68.1% water, and 3.1% bitumen on filling the flume. Approximately 2000 L=2400 kg of fFFT was deposited and the water was allowed to drain (dewater) for a week. Approximately 900 L of 0.25% solids water was drained.

Fluid fine tailings centrifuge cake (FFTC) was prepared by treating fluid fine tailings with a coagulant and a flocculant prior to dewatering by centrifugation to form a centrifuge cake, as described in Canadian Patent No. 2,787,607. The FFTC comprised 3.9 wt % bitumen, 48.6 wt % solids, 47.5 wt % water. The FFTC (2000 kg) was deposited into the flume using a chute and spread relatively evenly across the length of the flume over the fFFT layer.

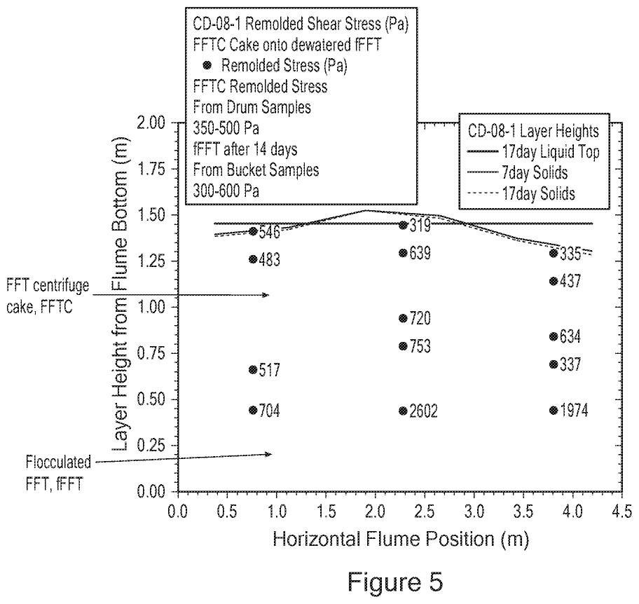

FIG. 5 shows the remolded shear stress measurements which show a clearer fFFT zone at the bottom of the flume where the dewatered fFFT started in the experiment. During the experiment, fFFT was produced and allowed to dewater for a week in the flume before placing the FFTC cake. This dewatering process removed about ½ of the water content from the fFFT and resulted in a large increase in the solids fraction of the dewatered fFFT relative to the originally produced fresh fFFT. Adding FFTC cake on top of the dewatered fFFT seemed to produce little effect except for applying some weight and compression to the fFFT below. There was no mixing or exchange between the two materials apparent from the visualization.

At the end of the test, the material compositions (solids %, fines %, clay %, d50) were largely the same between the apparent FFTC and fFFT zones. The cake strengths were similar to the baseline and other experiments, while in the lower position, a few data points were clearly in the very strong fFFT layer with static yield stresses of >6000 Pa and remolded shear strengths >2000 Pa. Hence, the fFFT at the base did not fail as a result of the co-deposition of FFTC on top of it. Rather, there is evidence that the surcharge on the fFFT as a result of FFTC promoted the dewatering and densification of the underlying fFFT.

### Example 3

This test was performed to demonstrate the efficacy of the co-deposition scenario as shown in FIG. 3C. This experiment started with an empty flume, and then fresh fFFT and FFTC were simultaneously co-deposited from opposite sides of the flume and allowed to interact with each other. fFFT was produced from FFT mixed with gypsum at 1000 g/tonne solids and flocculated in the dynamic mixer running at 1460 rpm with a Kc value of 63 mixing using a 0.4% SNF-A3338 polymer solution to give 954 ppm of polymer to solids. CST of fFFT was between 7 and 9 seconds. The total flow rate of fFFT was 22 Lpm. The fFFT comprised 29.6% solids, 66.4% water, 3.2% bitumen on filling the flume. Approximately 1950 L=2400 kg of fFFT were deposited in the flume. The fFFT was pumped into the right-hand side of the flume with a hose that was kept just above the free surface through the fill.

Approximately 1600 L=2350 kg of FFTC were placed on the left to the center of the flume. The first quarter of the FFTC were slid down the chute and slope, but the remaining FFTC were dropped on top of the established cake pile which was above the free surface. The chute was removed to prevent interference with the fFFT flow.

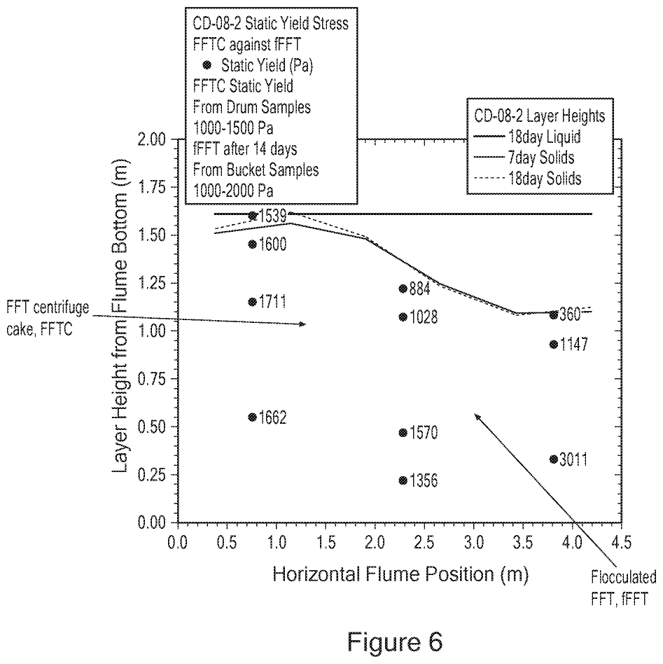

FIG. 6 shows sample data, in particular, static yield (Pa) stresses measured at various locations and profile depths of the test flume. FIG. 6 shows evidence for fFFT strengthening deep in the flume with the yield stress measurements. At shallower locations the results are similar to the FFTC cake side of the flume. The result confirm that co-deposition of both fFFT and FFTC did not negatively impact the dewatering and strength performance of either tailings product.

The results in the above three examples generally found that the majority of each material maintained its composition and properties. The dewatering and strength performance of the individual tailings stream or product was not adversely affected by co-depositing them. The properties and performance at the interface where the co-deposited tailings interacted was not degraded, in fact, in some cases, the properties and performance at the interface seemed to have been enhanced by co-deposition.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

We claim:

1. A process for co-depositing tailings streams and/or tailings products comprising:
providing a tailings containment structure; and
co-depositing at least two different tailings streams and/or tailings products into the tailings containment structure.

2. The process of claim 1, wherein the tailings streams are tailings derived from oil sands extraction operations that contain a fines fraction.

3. The process of claim 2, wherein the tailings streams are selected from the group consisting of straight coarse tailings, fluid fine tailings (FFT) such as mature fine tailings (MFT) from tailings ponds, and fine tailings from ongoing oil sands extraction operations.

4. The process of claim 1, wherein the tailings products are oil sands tailings that have been treated to aid in the consolidation of the tailings.

5. The process of claim 4, wherein the tailings products are selected from the group consisting of fluid fine tailings centrifuge cake, composite tailings, in-line flocculated fluid fine tailings, froth treatment tailings and fluid fine tailings mixed with clay shale.

6. The process as claimed in claim 1, wherein the at least two different tailings streams and/or tailings products comprises composite tailings and in-line flocculated fluid fine tailings.

7. The process of claim 1, wherein the at least two different tailings streams and/or tailings products comprises fluid fine tailings centrifuge cake and in-line flocculated fluid fine tailings.

8. The process as claimed in claim 1, wherein the tailings containment structure is partially filled with fluid fine tailings and recycle water and the at least two different tailings streams and/or tailings products comprises composite tailings and in-line flocculated fluid fine tailings, whereby the composite tailings and in-line flocculated fluid fine tailings are laterally co-deposited sub-aqueously into the fluid fine tailings and recycle water (RCW).

9. The process as claimed in claim 1, wherein the tailings containment structure is partially filled with fluid fine tailings and recycle water and the at least two different tailings streams and/or tailings products comprises composite tailings and in-line flocculated fluid fine tailings, whereby the composite tailings and in-line flocculated fluid fine tailings are laterally co-deposited sub-aerially into the fluid fine tailings and recycle water (RCW).
